(19) United States
(12) Patent Application Publication
(10) Pub. No.: US 2019/0071100 A1
(43) Pub. Date: Mar. 7, 2019

(54) AUTONOMOUS DRIVING ADJUSTMENT METHOD, APPARATUS, AND SYSTEM

(71) Applicant: DENSO CORPORATION, Kariya-city (JP)

(72) Inventor: Michel XAVIER, Kariya-city (JP)

(21) Appl. No.: 16/122,160

(22) Filed: Sep. 5, 2018

(30) Foreign Application Priority Data
Sep. 7, 2017 (JP) 2017-171912

(51) Int. Cl. B60W 50/12; G05D 1/00; B60W 50/08

(52) U.S. Cl. CPC B60W 50/12; G05D 1/0088; G05D 2201/0213; G05D 1/0061; B60W 50/082

(57) ABSTRACT

In an autonomous driving adjustment apparatus, a condition obtainer repeatedly obtains a driving-related condition during execution of autonomous driving control of a vehicle. The driving-related condition includes at least one of control information about the autonomous driving control of the vehicle, and environmental condition information around the vehicle during execution of the autonomous driving control of the vehicle. The condition obtainer obtains the driving-related condition in response to a driver's intervention in the autonomous driving control of the vehicle as an intervention-responsive driving-related condition. A parameter adjuster determines whether the intervention-responsive driving-related condition has been changed from a previous driving-related condition in the driving-related conditions. The previous driving-related condition is obtained immediately previous to the intervention-responsive condition. The parameter adjuster adjusts the at least one control parameter for the intervention-responsive driving-related condition upon determining that the intervention-responsive driving-related condition has been changed from the previous driving-related condition.

### CROSS REFERENCE TO RELATED APPLICATIONS

This application is based on and claims the benefit of priority from Japanese Patent Application 2017-171912 filed on Sep. 7, 2017, the disclosure of which is incorporated in its entirety herein by reference.

### TECHNICAL FIELD

The present disclosure relates to autonomous driving adjustment methods, apparatuses, and systems. More particularly, the present disclosure relates to these methods, apparatuses, and systems, each of which is capable of obtaining condition information associated with autonomous driving in response to driver's interventions.

### BACKGROUND

Autonomous driving, in other words self-driving, of vehicles has been developed rapidly. Developers have been studying how autonomous driving control is adjustable for driver's preferences, but they are at the stage of trial and error.

In driver assistance, Japanese Patent Application Publication No. 2015-128989, which will be referred to as a published patent document, discloses a driver assistance system configured to use driver feeling maps provided for plural driver assistance tasks. Each of the driver feeling maps includes a relationship among

(1) Exterior environment difficulty levels

(2) Levels of driver's driving skills

(3) Driver's feeling regions including a happy feeling region and an anxious feeling region

That is, when obtaining a current exterior environmental difficulty level and the level of the driver's driving skill in a selected driver feeling map corresponding to a selected driver assistance task, the driver assistance system refers to the selected driver feeling map using a current driver's point based on the current exterior environmental difficulty level and the level of the driver's driving skill, thus extracting one of the driver's feeling regions in which the current driver's point is located.

Then, if the extracted driver's feeling region is not the happy feeling region, the driver assistance system determines, in the selected emotional map, an assist quantity in the selected driver assistance task; the assist quantity enables the current driver's point to be shifted to be within the happy feeling region. Thereafter, the driver assistance system performs the selected driver assistance task based on the determined assist quantity.

### SUMMARY

The conventional technology disclosed in the published patent document estimates whether the driver's feeling is a happy feeling or an anxious feeling in accordance with a current exterior environmental difficulty level and the level of the driver's driving skill.

That is, even if the autonomous driving control is adjusted based on the conventional technology disclosed in the published patent document, the accuracy of the autonomous driving control may be lowered, because the estimated driver's feeling is an unstable factor. This therefore may make it difficult to adjust the autonomous driving control to be suitable for driver's preferences.

In view of the above circumstances, one aspect of the present disclosure seeks to provide autonomous driving adjustment methods, apparatuses, and systems, each of which is capable of addressing the issue set forth above.

According to a first exemplary aspect of the present disclosure, there is provided an autonomous driving adjustment apparatus for adjusting at least one control parameter used for execution of autonomous driving control of a vehicle. The autonomous driving adjustment apparatus includes a condition obtainer configured to repeatedly obtain a driving-related condition during execution of autonomous driving control of a vehicle. The driving-related condition includes at least one of control information about the autonomous driving control of the vehicle, and environmental condition information around the vehicle during execution of the autonomous driving control of the vehicle. The condition obtainer is configured to obtain the driving-related condition in response to a driver's intervention in the autonomous driving control of the vehicle as an intervention-responsive driving-related condition. The autonomous driving adjustment apparatus includes a parameter adjuster configured to determine whether the intervention-responsive driving-related condition has been changed from a previous driving-related condition in the driving-related conditions. The previous driving-related condition is obtained immediately previous to the intervention-responsive condition. The parameter adjuster is configured to adjust the at least one control parameter for the intervention-responsive driving-related condition upon determining that the intervention-responsive driving-related condition has been changed from the previous driving-related condition.

According to a second exemplary aspect of the present disclosure, there is provided an autonomous driving adjustment system. The autonomous driving adjustment system includes a control apparatus to be installed in a vehicle, and an autonomous driving adjustment apparatus. The control apparatus includes an autonomous driving controller configured to execute autonomous driving control of the vehicle in accordance with at least one control parameter, and an information sender configured to repeatedly send, to the autonomous driving adjustment apparatus, a driving-related condition while the autonomous driving controller is executing the autonomous driving control of the vehicle. The driving-related condition includes at least one of control information about the autonomous driving control of the vehicle, and environmental condition information around the vehicle. The information sender is configured to send, to the autonomous driving adjustment apparatus, the driving-related condition in response to a driver's intervention in the autonomous driving control of the vehicle as an intervention-responsive driving-related condition. The autonomous driving adjustment apparatus includes a condition obtainer configured to obtain the driving-related conditions sent from the information sender. The driving-related conditions include the intervention-responsive driving-related condition. The autonomous driving adjustment apparatus includes a parameter adjuster configured to determine whether the intervention-responsive driving-related condition has been changed from a previous driving-related condition in the driving-related conditions. The previous driving-related condition being obtained immediately previous to the intervention-responsive condition. The parameter adjuster is configured to adjust the at least one control parameter for the intervention-responsive driving-related condition upon determining that the intervention-responsive driving-related condition has been changed from the previous driving-related condition.

According to a third exemplary aspect of the present disclosure, there is provided an autonomous driving adjustment method for adjusting at least one control parameter used for execution of autonomous driving control of a vehicle. The autonomous driving adjustment method includes

(1) Repeatedly obtaining a driving-related condition during execution of autonomous driving control of a vehicle, the driving-related condition including at least one of control information about the autonomous driving control of the vehicle, and environmental condition information around the vehicle during execution of the autonomous driving control of the vehicle, the obtaining step obtaining the driving-related condition in response to a driver's intervention in the autonomous driving control of the vehicle as an intervention-responsive driving-related condition

(2) Determining whether the intervention-responsive driving-related condition has been changed from a previous driving-related condition in the driving-related conditions, the previous driving-related condition being obtained immediately previous to the intervention-responsive condition

(3) Adjusting the at least one control parameter for the intervention-responsive driving-related condition upon determining that the intervention-responsive driving-related condition has been changed from the previous driving-related condition.

Each of the first to third exemplary aspects of the present disclosure makes it possible to adjust the at least one control parameter for the intervention-responsive driving-related condition upon determining that the intervention-responsive driving-related condition has been changed from the previous driving-related condition. This configuration enables the at least one of the control parameters to be adjusted to satisfy the driver's preferences during the autonomous driving control, resulting in reduction of driver's uncomfortable feeling for the autonomous driving of the vehicle.

### BRIEF DESCRIPTION OF THE DRAWINGS

Other aspects of the present disclosure will become apparent from the following description of embodiments with reference to the accompanying drawings in which:

FIG. 1 is a system configuration diagram schematically illustrating an autonomous driving adjustment system according to an exemplary embodiment of the present disclosure;

FIG. 2 is a block diagram schematically illustrating a control structure of the autonomous driving adjustment system illustrated in FIG. 1;

FIG. 3 is a diagram schematically illustrating a variable setting historical file according to the exemplary embodiment of the present disclosure;

FIG. 4 is a flowchart schematically illustrating an autonomous driving adjustment routine according to the exemplary embodiment of the present disclosure;

FIG. 5 is a view schematically illustrating an example of how an autonomous driving controller is executing autonomous driving control of a vehicle;

FIG. 6 is a flowchart schematically illustrating an autonomous driving control subroutine according to the exemplary embodiment of the present disclosure;

FIGS. 7A and 7B are a joint view schematically illustrating how the autonomous driving control subroutine is carried out.

### DETAILED DESCRIPTION OF EMBODIMENT

The following describes an exemplary embodiment of the present disclosure with reference to the accompanying drawings.

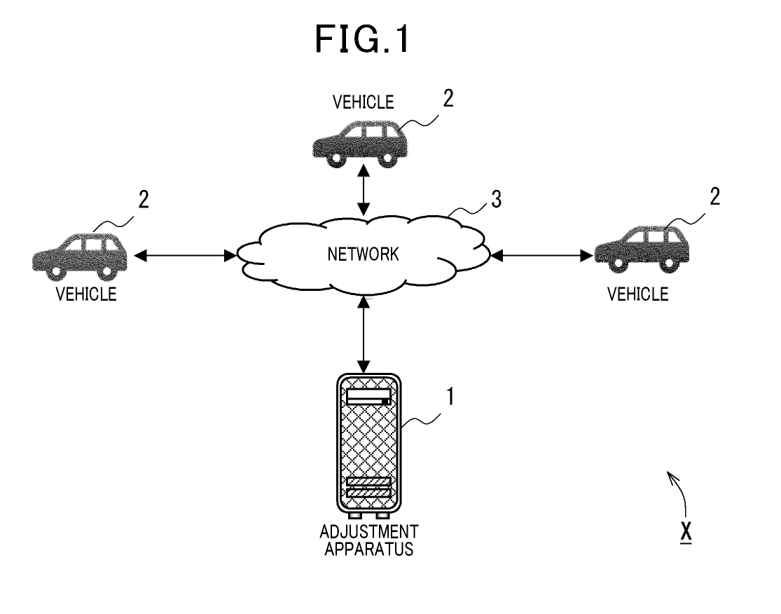

The following describes an example of the configuration of an autonomous driving adjustment system X according to the exemplary embodiment of the present disclosure with reference to FIG. 1.

Referring to FIG. 1, the autonomous driving adjustment system X includes an adjustment apparatus 1 and at least one vehicle 2 communicable with the adjustment apparatus 1 via an available network 3. In FIG. 1, three vehicles 2 are provided to be communicable with the adjustment apparatus 1 via the network 3.

The adjustment apparatus 1 serves as an autonomous driving adjustment apparatus for adjusting how each of the vehicles 2 is autonomously controlled.

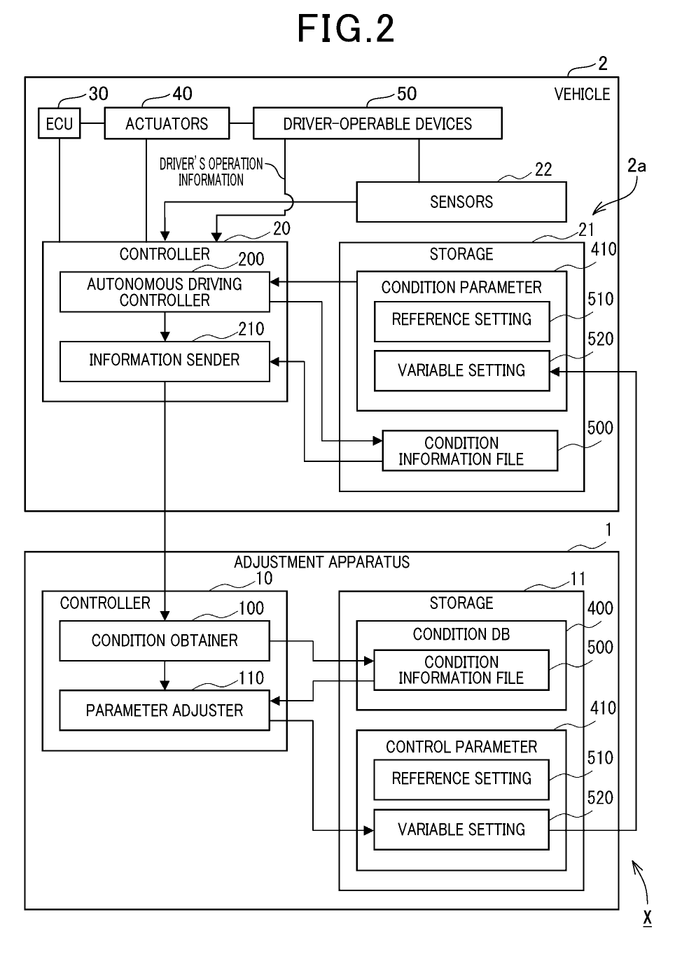

Specifically, while a control apparatus 2a of each vehicle 2 (see FIG. 2) is executing autonomous driving control of the vehicle 2 in an autonomous driving mode, the adjustment apparatus 1 is configured to obtain, from each vehicle 2, a condition information file 500 (see FIG. 2) associated with the autonomous driving of the vehicle 2 repeatedly, i.e. cyclically, and each time of a driver, who is, for example, sitting on a driver's seat of the vehicle 2, intentionally intervenes in the autonomous driving. The condition information file 500 shows a driving-related condition of the vehicle 2 including information about the autonomous driving control of the vehicle 2 and environmental condition information around the vehicle 2 during execution of the autonomous driving control of the vehicle 2. Note that a file according to this embodiment for example shows the collection of data items or information items.

The adjustment apparatus 1 is also configured to

(1) Analyze an intervention-responsive condition information file 500 obtained from each vehicle 2 in response to a driver's intervention

(2) Determine, based on a result of the analyzation, whether an intervention-responsive driving-related condition represented by the intervention-responsive condition information file 500 has been changed by at least a predetermined threshold amount from the last driving-related condition represented by the lastly obtained condition information file 500 immediately previous to the intervention-responsive condition information file 500 before the occurrence of the driver's intervention

(3) When the intervention-responsive driving-related condition represented by the intervention-responsive condition information file 500 has been changed by at least the predetermined threshold amount from the last driving-related condition represented by the lastly obtained condition information file 500, adjust control parameters 410 of the autonomous driving such that the adjusted control parameters 410 satisfy or adapt to the currently obtained intervention-responsive condition information file 500

(4) Send the adjusted control parameters 410 to the at least one vehicle 2, so that the control apparatus 2a of the at least one vehicle 2 reflects the adjusted control parameters 410 in control of the autonomous driving of the at least one vehicle 2

Because the control parameters 410 of the autonomous driving are adjusted to satisfy the currently obtained condition information file 500 that is based on the driver's intervention to the autonomous driving, the control parameters 410 of the autonomous driving are adapted to the driver's preferences. This configuration therefore enables the control parameters 410 of the autonomous driving, which are adapted to the driver's preferences, to be reflected in control of the autonomous driving of the at least one vehicle 2.

For example, the adjustment apparatus 1 is comprised of a personal computer, a server, or a mainframe computer.

The control apparatus 2a of each vehicle 2 is capable of performing at least level 1 of autonomous driving of six previously defined levels; level 1 represents a driver assistance mode for assisting the driver's driving of the vehicle 2. Note that level 2 represents a partial automation mode in which the driver must be able to control the vehicle 2 if corrections are needed, but the driver is no longer in control of the speed and steering of the vehicle 2. Level 3 represents a conditional automation mode in which the control apparatus 2a is configured to perform complete control of vehicle functions such as speed, steering, and monitoring the environment, but the driver must be present to provide any corrections when needed. Level 4 represents a high automation mode in which the control apparatus 2a is capable of performing complete control of the vehicle 2 in predetermined specific situations. Level 5 represents a full automation mode in which the control apparatus 2a is capable of performing complete control of the vehicle 2 in any situation.

For example, the control apparatus 2a of each vehicle 2 is configured to execute at least one of predetermined autonomous driving programs to thereby perform autonomous driving in one of the autonomous driving levels (driving modes) 1 to 5. In addition, the driver of each vehicle 2 is capable of manually driving the vehicle 2 in a manual mode without no assistance from the control apparatus 2a or some assistance from the control apparatus 2a if need arises.

The control apparatus 2a of each vehicle 2 is configured to obtain the condition information file 500 associated with the autonomous driving of the vehicle 2 while performing the autonomous driving of the vehicle 2 in one of the autonomous driving modes (levels) 1 to 5 each time a driver of the vehicle 2 intentionally intervenes in the autonomous driving. Then, the control apparatus 2a of each vehicle 2 is configured to send, to the adjustment apparatus 1, the condition information file 500 each time of obtaining the condition information file 500.

Detailed information about the condition information file 500 and driver's intervention will be described later.

Note that “vehicles 2” in the exemplary embodiment are not limited to available passenger vehicles, motorcycles, and trucks, so that test vehicles, driving simulators, or driving game machines can be included in “vehicles 2”. In addition, “driver” in the exemplary embodiment can include a user of the vehicle, who can execute any intervention in the autonomous driving, such as a user of the vehicle 2 who can actually drive the vehicle 2 or an occupant of the vehicle 2 who can execute any intervention in the autonomous driving.

A cell-phone network, a wide area network, such as the internet, or an internet protocol (IP) network can be used as the network 3.

The following describes an example of the configuration of the adjustment apparatus 1 and an example of the configuration of the control apparatus 2a of each vehicle 2 with reference to FIG. 2.

The adjustment apparatus 1 includes various functional units including a controller 10 and a storage 11. Each of the other units is communicably connected to the controller 10, enabling the controller 10 to control the other units.

The control apparatus 2a of each vehicle 2 includes various functional units including a controller 20 and a storage 21, and sensors 22. Each of the other units is communicably connected to the controller 20, enabling the controller 20 to control the other units. Each of the sensors 22 is designed to control itself or to be controlled by the controller 20. The controller 20 can be connected to an in-vehicle network, such as a controlled area network (CAN) or a Local Interconnect Network (LIN).

Each of the controllers 10 and 20 is designed as an information processing unit comprised of a processing unit, such as a central processing unit (CPU), a micro processing unit (MPU), a graphics processing unit (GPU), a tensor processing unit (TPU), a data flow processor (DFP), a digital signal processor (DSP), or an application specific integrated circuit (ASIC).

Each of the storages 11 and 21 is comprised of non-transitory tangible storage media including a main storage unit, such as a random access memory (RAM), and an auxiliary storage unit, such as a read only memory (ROM), a solid state disc (SSD) device, and a hard disc drive (HDD). Each of the storages 11 and 21 can include a flash memory card and/or an optical storage medium.

Various programs including control programs for causing the controller 10 of the adjustment apparatus 1 to perform various tasks, i.e. routines, are stored in the auxiliary storage unit of the storage 11. The control programs include, for example, an operating system (OS) and application software programs. In addition, various data items usable by the controller 10 are also stored in the storage 11.

Similarly, various programs including control programs for causing the controller 20 to control the corresponding vehicle 2 are stored in the auxiliary storage unit of the storage 21. Similarly, the control programs include, for example, an OS and application software programs. In addition, various data items usable by the controller 20 are also stored in the storage 21.

The controller 10 reads one of the control programs from the auxiliary storage unit of the storage 11, loads the readout control program into the main storage unit of the storage 11, and executes the loaded control program to thereby execute the routine corresponding to the loaded control program. In other words, the controller 10 executes the loaded control program to thereby implement predetermined functional blocks based on the loaded control program. In addition, the controller 10 is configured to control overall operations of the adjustment apparatus 1.

Similarly, the controller 20 of each vehicle 2 reads one of the control programs from the auxiliary storage unit of the storage 21, loads the readout control program into the main storage unit of the storage 21, and executes the loaded control program to thereby execute the routine corresponding to the loaded control program. In other words, the controller 20 executes the loaded control program to thereby implement predetermined functional blocks based on the loaded control program. In addition, the controller 20 of each vehicle 2 is configured to control overall operations of the control apparatus 2a of the corresponding vehicle 2.

Each vehicle 2 includes actuators 40 that enable the vehicle 2 to be autonomously driven in a selected one of the autonomous driving modes. Note that each vehicle 2 includes an internal combustion engine and an electronic control unit (ECU) 30 for controlling the engine and the actuators 40. At that time, the ECU 30 can serve as the controller 20.

For example, the actuators 40 of each vehicle 2 according to the exemplary embodiment include a drive motor for rotatably driving wheels of the vehicle 2, a steering motor for steering, for example, a steering wheel of the vehicle 2 to thereby steering the vehicle 2, and brake actuators, which are linked to a brake pedal, configured to brake the respective wheels of the vehicle 2.

The actuators 40 of each vehicle 2 also include a throttle-valve actuator for controlling the opening of a throttle valve mounted in, for example, an intake manifold of the engine and linked to an accelerator pedal, thus controlling the amount of air or air-fuel mixture that reaches the cylinders of the engine.

The actuators 40 further include a horn for sounding an alarm when energized, light devices, including turn light indicators, for outputting light when energized.

Each vehicle 2 includes driver-operable devices 50 that are operable by the driver associated with the driving of the vehicle 2.

For example, the driver operable devices 50 include, as first group of devices that are directly associated with the driving of the vehicle 2, a steering wheel, an accelerator pedal, a brake pedal, a shift lever, a drive mode switch, a horn switch, light switches, and other similar driver-operable devices.

The steering wheel allows the driver to control the front wheel steering of the vehicle 2 when operated by the driver. The accelerator pedal linked to the throttle valve can be depressed by the driver of the vehicle 2, and the brake pedal linked to the brake actuators can be depressed by the driver of the vehicle 2. The shift lever is configured to select one of the gear positions of the transmission when operated by the driver of the vehicle 2.

The drive mode switch allows the driver of the vehicle 2 to select between five modes: Normal, Power Eco, EV, and Autonomous driving when operated by the driver. For example, the opening of the throttle valve can be adjusted based on a selected one of the Normal, Power Eco, and EV modes. When the drive mode switch is switched to the Autonomous driving mode, the control apparatus 2a starts autonomous driving of the vehicle 2. The horn switch causes the horn to sound when turned on by the driver. Similarly, each light switch causes the corresponding one of the light devices to emit light when turned on by the driver.

The driver operable devices 50 also include a second group of devices that are operable by the driver and are not directly associated with the driving of the vehicle 2, such as an in-vehicle camera, a navigation device, a radio device, an audio device, an air conditioner, an in-vehicle telephone, power windows, electronic mirrors, movable seats, or the like.

In addition, the driver operable devices 50 can include a voice input/output device and/or a vibration input device that enable the driver to feedback, to the controller 10, how the drive of the vehicle 2 in a selected autonomous driving mode or the manual mode, how the drive of the vehicle 2 is being carried out. The driver operable devices 50 can include a drive recorder for recording, for example, the front view as a time-related composite audio and video signal while, for example, the vehicle 2 is travelling. The time-related composite audio and video signal is comprised of time-related frame images time-related audio data items.

Note that each of the adjustment apparatus 1 and the control apparatus 2a of each vehicle 2 can include other components and/or functional modules in addition to the components set forth above. Each component of the adjustment apparatus 1 and the control apparatus 2 can include components to be controlled. Some components in the adjustment apparatus 1 can be integrated with each other, and some components in the control apparatus 2a can be integrated with each other. For example, the controller 10 and the storage 11 can be integrated with each other, and the controller 20 and the storage 21 can also be integrated with each other.

Each vehicle 2 includes various sensors 22 for measuring vehicle control condition information of the vehicle 2 and environmental condition information around the vehicle 2. The vehicle control condition information represents how the driving of the vehicle 2 is controlled, and the environmental condition information represents environmental conditions around the vehicle 2.

For example, the sensors 22 include a vehicle speed sensor, a steering sensor, an accelerator sensor, a brake sensor, a shift position sensor, a GPS sensor, and environmental condition sensors, and so on.

The vehicle speed sensor repeatedly measures the speed of the vehicle 2, and repeatedly outputs, to the controller 10, a measurement signal indicative of the speed of the vehicle 2. The steering sensor repeatedly measures a steering angle of the vehicle 2, and repeatedly outputs, to the controller 10, a measurement signal indicative of the steering angle of the vehicle 2.

The accelerator sensor measures an amount of the driver's operation of the accelerator pedal upon the driver's operation of the accelerator pedal, and outputs, to the controller 10, a measurement signal indicative of the measured amount of the driver's operation of the accelerator pedal. The brake sensor measures an amount of the driver's operation of the brake pedal upon the driver's operation of the brake pedal, and outputs, to the controller 10, a measurement signal indicative of the measured amount of the driver's operation of the brake pedal. The shift position sensor measures a driver's selected gear position of the transmission of the vehicle 2, and outputs, to the controller 10, a measurement signal indicative of the driver's selected gear position of the transmission. The GPS sensor includes a receiver and a controller. The receiver receives GPS signals from GPS satellites, and the controller determines the current location of a predetermined point, such as the center of gravity, of the vehicle 2 based on the received GPS signals.

Additionally, the environmental condition sensors include, for example, a radar sensor, an image sensor, and weather sensors for measuring

(1) Other objects, such as other vehicles, pedestrians, and/or obstacles, located around the vehicle 2

(2) Information indicative of the road on which the vehicle 2 is travelling has a substantially straight shape or a curved shape

(3) Information indicative of the number of lanes of the road on which the vehicle 2 is going to travel

(4) Information indicative of whether the road is a sloping road

(5) Weather information indicative of the weather condition, such as a bright condition, a rain condition, a cloud condition, a snow condition, a fog condition, or a sandstorm condition around the vehicle 2

The vehicle control condition information and the environmental condition information set forth above are successively sent from the sensors 22 and/or via the in-vehicle network to the controller 10.

The controller 10 of the adjustment apparatus 1 functionally includes, for example, a condition obtainer 100 and a parameter adjuster 110. The storage 11 of the adjustment apparatus 1 stores a condition database (DB) 400 and control parameters 410.

The controller 20 of the control apparatus 2a of each vehicle 2 functionally includes, for example, an autonomous driving controller 200 and an information sender 210. The storage 21 of the control apparatus 2a of each vehicle 2 stores the control parameters 410 and condition information files 500.

The autonomous driving controller 200 of each vehicle 2 controls the actuators 40 to perform autonomous driving of the vehicle 2 in accordance with

(1) Settings of the control parameters 410 stored in the storage 21

(2) The measurement signals sent from the sensors 22

Specifically, the autonomous driving controller 200 autonomously controls a turning angle of the steering wheel, the rotational speed of the motor, i.e. the speed of the vehicle 2, and braking of each wheel, thus autonomously driving the vehicle 2 in accordance with the values of the control parameters 410 while autonomously adapting to a current environment condition around the vehicle 2.

For example, the control parameters 410 include at least one of

(1) The following distance between the vehicle 2 and a preceding vehicle, which can be obtained based on the measurement signals from the radar sensor and image sensor of the sensors 22

(2) The acceleration or deceleration of the vehicle 2, which can be obtained based on the measurement signal sent from the accelerator sensor or brake sensor of the sensors 22

(3) The steering rate of the vehicle 2, which can be obtained based on the measurement signal sent from the steering sensor of the sensors 22

While autonomously driving the vehicle 2, the autonomous driving controller 200 is configured to

(1) Obtain the vehicle control condition information and the environmental condition information successively sent from the sensors 22 and/or via the in-vehicle network

(2) Repeatedly, i.e. cyclically, generate a condition information file 500 based on the vehicle control condition information and the environmental condition information currently obtained thereby, thus storing the condition information file 500 in the storage 21

The vehicle control condition information includes, for example, the speed of the vehicle 2, the steering angle of the vehicle 2, and how the vehicle 2 is accelerated or decelerated, which are respectively measured by the corresponding sensors in the sensors 22.

Specifically, the environmental condition information for example includes

(1) Time condition information

(2) Weather condition information

(3) Road condition information

(4) Traffic condition information

(5) Hazardous condition information

The time condition information represents which times of day the vehicle 2 is travelling in, the times of day including, for example, morning, daytime, evening, and night time.

The weather condition information represents the weather condition, such as a bright condition, a rain condition, a cloud condition, a snow condition, a fog condition, or a sandstorm condition around the vehicle 2, which can be measured by the weather sensors and/or can be determined based on images around the vehicle 2 captured by the image sensor

The road condition information includes

1. The type of a road on which the vehicle 2 is travelling including whether the travelling road is an urban road or an expressway, how many lanes the travelling road has, and whether there are oncoming lanes in the travelling road

2. Speed limit of the travelling road

3. Whether passing is permitted for the travelling road

4. Whether there is a stop sign for the travelling road

5. Whether there is an entry sign for the travelling road

6. Whether there is a falling-rocks sign for the travelling road

7. Whether there is a caution children sign for the travelling road

8. Whether there are other traffic regulations for the travelling road

For example, these items of the road condition information can be obtained based on the images in front of the vehicle 2 captured by the image sensor.

The traffic condition information includes traffic conditions around the vehicle 2 at the current time, which include

1. Other objects, such as other vehicles, pedestrians, and/or obstacles, located on the travelling road ahead of the vehicle 2 at the current time

2. An average speed of the other vehicles travelling in front of the vehicle 2

For example, these items of the traffic condition information can be obtained based on the images in front of the vehicle 2 captured by the image sensor and/or can be obtained based on traffic information about an estimated travelling course of the vehicle 2 or its peripheral area; the traffic information is received via the network 3.

The hazardous condition information includes hazard situations in the estimated travelling course of the vehicle 2 or its peripheral area; the hazard situations include, for example, a situation where there are obstacles, a situation where there is at least one sinkhole in at least one road, a situation where there are cargoes fallen on at least one road, and a situation where there is at least one accident happened on at least one road.

In particular, the autonomous driving controller 200 is configured to determine whether there is a driver's intervention in the autonomous driving of the vehicle 2 while performing the autonomous driving of the vehicle 2.

For example, the autonomous driving controller 200 detects, as a driver's intervention, a driver's intentional feedback thereto while the autonomous driving controller 200 is performing autonomous driving of the vehicle 2.

For example, while autonomously performing driving of the vehicle 2, the autonomous driving controller 200 detects a driver's intervention upon the occurrence of driver's operation information based on a driver's operation of one of the driver operable devices 50.

Specifically, while autonomously performing driving of the vehicle 2, the autonomous driving controller 200 detects a driver's intervention upon the occurrence of driver's operation information based on a driver's operation of one of the driver operable devices 50. The driver's operation of one of the first group of devices in the driver operable devices 50 includes

(1) A driver's operation of the accelerator pedal of the driver operable devices 50 to accelerate the vehicle 2

(2) A driver's operation of the brake pedal of the driver operable devices 50 to decelerate the vehicle 2

(3) A driver's operation of the shift lever of the driver operable devices 50 to change a current gear position of the transmission to another

(4) A driver's operation of the drive mode switch of the driver operable devices 50 to change the current mode, i.e. the autonomous driving mode, to another mode

(5) A driver's turn-on operation of the horn switch of the driver operable devices 50

(6) A driver's turn-on operation of one of the light switches of the driver operable devices 50

Because the first group of devices in the driver operable devices 50 is directly associated with the driving of the vehicle 2, it is possible for the driving controller 200 to determine that there is a possibility of the driver having a feeling of anxiety about the autonomous driving.

In addition, when the driving controller 200 successively reproduces the frame images and corresponding audio signals based on the composite video and audio signal recorded in the drive recorder at a current time, and the driver of the vehicle 2 inputs an evaluation trigger to a currently reproduced frame image at a corresponding time, the autonomous driving controller 200 can be configured to determine that a driver's intervention has occurred at the corresponding trigger time.

That is, the driving controller 200 can be configured to obtain a condition information file 500 generated at or closest to the trigger timing from the storage 21, and output the obtained condition information file 500 to the information sender 210.

Note that, while autonomously performing driving of the vehicle 2, the autonomous driving controller 200 can detect a driver's intervention upon the occurrence of driver's operation information based on a driver's operation of one of the second group of devices in the driver operable devices 50. Because the second group of devices in the driver operable devices 50 is not directly associated with the driving of the vehicle 2, it is possible for the controller 20 to determine that there is a possibility of the driver having a feeling of boredom about the autonomous driving, in other words, a feeling of wishing to perform manual driving.

The autonomous driving controller 200 can store the condition information file 500 while categorizing the condition information file 500 into the vehicle control condition information, the time condition information, the weather condition information, the road condition information, the traffic condition information, and the hazardous condition information.

The autonomous driving controller 200 can store the condition information file 500 in the storage 21 such that the time of the corresponding file being stored is assigned to the condition information file 500. This enables whether a condition information file 500 stored in the storage 21 at a current time is changed by at least the predetermined threshold amount from the condition information file 500 stored at an immediately previous to the current time to be easily determined.

The autonomous driving controller 200 can be configured to execute the autonomous driving of the corresponding vehicle 2 to cause the corresponding vehicle 2 to perform the autonomous driving of the corresponding vehicle 2 for the driver.

The parameter adjuster 110 of the adjustment apparatus 1 can be configured to determine whether there is a driver's intervention in autonomous driving of the vehicle 2 that is being carried out by the autonomous driving controller 200 of each vehicle 2.

The information sender 210 is configured to send, to the adjustment apparatus 1, the condition information file 500 each time the autonomous driving controller 200 generates the condition information file 500 and stores it in the storage 21. Note that the adjustment apparatus 1 can be configured to successively obtain the condition information file 500 each time the autonomous driving controller 200 generates the condition information file 500 and stores it in the storage 21.

That is, when the intervention-responsive condition information file 500 is generated by the autonomous driving controller 200, the intervention-responsive condition information file 500 is sent to the adjustment apparatus 1 from the information sender 210.

The information sender 210 can be configured to send, to the adjustment apparatus 1, the measurement signals sent from the sensors 22.

The condition obtainer 100 is configured to successively obtain the condition information file 500 and store it in the condition DB 400 each time the condition information file 500 is generated by the autonomous driving controller 200.

Like the autonomous driving controller 200, the condition obtainer 100 is configured to store the condition information file 500 in the condition DB 400 while categorizing the condition information file 500 into the vehicle control condition information, the time condition information, the weather condition information, the road condition information, the traffic condition information, and the hazardous condition information. If the condition information file 500 has been categorized into the vehicle control condition information, the time condition information, the weather condition information, the road condition information, the traffic condition information, and the hazardous condition information, the condition obtainer 100 can store the categorized condition information file 500 in the condition DB 400.

The condition obtainer 100 can store the condition information file 500 in the condition DB 400 such that the time of the corresponding file being stored is assigned to the condition information file 500. This enables whether a condition information file 500 stored in the storage 11 at a current time is changed by at least the predetermined threshold amount from the condition information file 500 stored at an immediately previous to the current time to be easily determined.

When the condition obtainer 100 obtains the intervention-responsive condition information file 500, the parameter adjuster 110 is configured to

(1) Analyze an intervention-responsive driving-related condition, i.e. an intervention-responsive autonomous driving situation, which is being carried out by the autonomous driving controller 200, represented by the intervention-responsive condition information file 500

(2) Determine whether the intervention-responsive driving-related condition represented by the intervention-responsive condition information file 500 has been changed by at least the predetermined threshold amount from the previous driving-related condition represented by the condition information file 500 stored in the condition DB 400 immediately previous to the intervention-responsive condition information file 500

(3) Change, i.e. adjust, a current value of at least one of the control parameters 410 to a different value of the corresponding at least one of the control parameters 410 upon determining that the intervention-responsive driving-related condition represented by the intervention-responsive condition information file 500 has been changed by at least the predetermined threshold amount from the previous driving-related condition represented by the condition information file 500 stored in the condition DB 400 immediately previous to the intervention-responsive condition information file 500

That is, the condition obtainer 100 estimates that, because an executed content in the autonomous driving control has been disliked by the driver, the driver's intervention has occurred. In other words, the condition obtainer 100 estimates that, because an executed content in the autonomous driving control has made the driver anxious, the driver's intervention has occurred.

For example, the parameter adjuster 110 is configured to change the current value of at least one of the control parameters 410 to a different value of the corresponding at least one of the control parameters 410; this different value of the at least one of the control parameters 410 prevents the driver from having an anxious feeling to thereby prevent the driver from intervention in the autonomous driving while ensuring safe autonomous driving of the vehicle 2. In other words, even if the autonomous driving of the vehicle 2 is carried out safely, a controlled value of, for example, the acceleration, the steering rate, or the following distance between a preceding vehicle and the vehicle 2 does not necessarily cause the driver to have a secure feeling.

For this reason, the parameter adjuster 110 adjusts values of at least one of the control parameters 410 to be suitable for respective different drivers while ensuring safe autonomous driving of the vehicle 2.

In other words, the parameter adjuster 110 is configured to learn driver's preferences about the autonomous driving based on an intervention-responsive condition information file 500 obtained each time a driver's intervention to the autonomous driving of the vehicle 2 occurs, thus adjusting the autonomous driving to be suitable for the driver's preferences about the autonomous driving of the vehicle 2.

The parameter adjuster 110 can be configured to adjust a value of the at least one of the control parameters 410 to thereby execute control of the autonomous driving of the vehicle 2 in a more moderate manner.

Specifically, the parameter adjuster 110 is configured to

(1) Determine whether the intervention-responsive driving-related condition represented by the intervention-responsive condition information file 500 has been changed by at least the predetermined threshold amount from the previous driving-related condition represented by the condition information file 500 stored in the condition DB 400 immediately previous to the intervention-responsive condition information file 500

(2) Change, i.e. adjust, a current value of at least one of the control parameters 410 to a different value of the corresponding at least one of the control parameters 410 to thereby cause control of the autonomous driving of the vehicle 2 to be in a more moderate manner upon determining that the intervention-responsive driving-related condition represented by the intervention-responsive condition information file 500 has been changed by at least the predetermined threshold amount from the previous driving-related condition represented by the condition information file 500 stored in the condition DB 400 immediately previous to the intervention-responsive condition information file 500.

As a first example, if the following distance between the vehicle 2 and a preceding vehicle ahead of the vehicle 2 has decreased based on control of the autonomous driving, and a driver's intervention has occurred, the parameter adjuster 110 adjusts a current setting of the following distance to be longer.

As a second example, if the acceleration of the vehicle 2 has increased based on control of the autonomous driving, and a driver's intervention has occurred, the parameter adjuster 110 adjusts a current setting of the acceleration to be smaller.

As a third example, if the deceleration of the vehicle 2 has increased based on control of the autonomous driving, and a driver's intervention has occurred, the parameter adjuster 110 adjusts a current setting of the deceleration to be smaller.

As a fourth example, if the steering rate of the vehicle 2 has increased based on control of the autonomous driving, and a driver's intervention has occurred, the parameter adjuster 110 adjusts a current setting of the steering rate to be lower.

This adjustment of the parameter adjuster 110 makes it possible to give the driver a secure feeling while ensuring safe autonomous driving of the vehicle 2.

For example, as illustrated in FIG. 2, the parameter adjuster 110 includes reference settings 510 and variable settings 520 for the respective control parameters 410. That is, the autonomous driving controller 200 of each vehicle 2 is configured to execute one of

(1) Control of autonomous driving of the vehicle 2 based on the reference settings 510 of the respective control parameters 410

(2) Control of autonomous driving of the vehicle 2 based on the variable setting 520 of the respective control parameters 410

Specifically, the parameter adjuster 110 is capable of changing a value of the variable setting 520 of each of the control parameters 410. While performing the autonomous driving control of the vehicle 2 based on the variable settings 520 of the control parameters 410, the autonomous driving controller 200 maintains the reference settings 510 unchanged.

The parameter adjuster 110 can be configured to change the variable setting 520 of each of the control parameters 410 within a predetermined range that enables safe autonomous driving of the vehicle 2 to be carried out.

Note that the condition information files 500 cyclically sent from each vehicle 2 can each include attribute information of a corresponding driver; the attribute information can include, for example, the age, the sex, the physical ability, the recognition ability, and/or driving ability of the corresponding driver. The parameter adjuster 110 in this modification can be configured to determine the reference settings 510 and the variable settings 520 of the respective control parameters 410 for each vehicle 2 in accordance with the attribute information of the driver of the corresponding vehicle 2. This modification therefore enables the reference settings and optimum variable settings for the respective control parameters 410, which are optimally suitable for the physical ability, the recognition ability, and/or driving ability of each driver, to be determined.

The reference settings 510 of the respective control parameters 410 are initially stored in each of the storages 11 and 21.

Note that a variable setting 520 for each of the control parameters 410 is determined each time an intervention-responsive driving-related condition is generated based on the intervention-responsive condition information file 500.

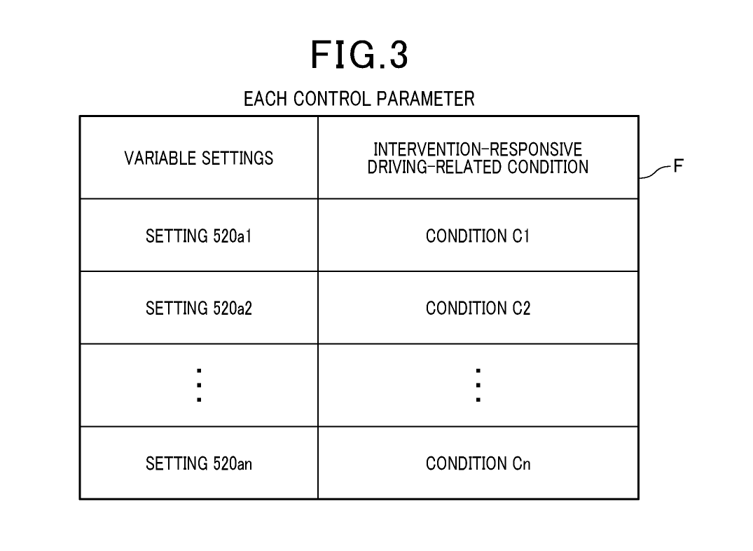

The parameter adjuster 110 is therefore configured to store, in the storage 11, a variable-setting historical file F including values 520a1, . . . , 520an of the variable setting 520 for each of the control parameters 410 to be correlated with the respective intervention-responsive driving-related conditions C1, . . . , Cn in, for example, a table format (see FIG. 3).

The intervention-responsive driving-related conditions C1, . . . , Cn are not limed to the intervention-responsive driving-related conditions that have been already carried out.

Specifically, the values 520a1, . . . , 520an of the variable setting 520 for each of the control parameters 410 can be stored in the storage 11 to be correlated with previously prepared respective intervention-responsive driving-related conditions C1, . . . , Cn in, for example, a table format.

The parameter adjuster 110 is configured to send, at a predetermined timing described later, the variable-setting historical file F including the values 520a1, . . . , 520an of the variable setting 520 for each of the control parameters 410 to be correlated with the respective intervention-responsive driving-related conditions C1, . . . , Cn to each vehicle 2.

The autonomous driving controller 200 of each vehicle 2 receives the control parameters 410 and stores the control parameters 410 in the storage 21 each time the variable settings 520 of the control parameters 410 are sent thereto from the parameter adjuster 110.

If a currently generated intervention-responsive driving-related condition is identical to one of the intervention-responsive driving-related conditions C1, . . . , Cn stored in the storage 21, the autonomous driving controller 200 can change the reference value of each of at least one of the control parameters 410 to the variable settings 520 correlated with the one of the intervention-responsive driving-related conditions C1, . . . , Cn.

The condition DB 40 is configured to store the condition information files 500 respectively corresponding to the driving-related conditions. As described above, each condition information file 500 stored in the condition DB 40 can be categorized into the vehicle control condition information, the time condition information, the weather condition information, the road condition information, the traffic condition information, and the hazardous condition information.

Note that the condition information files 500 can each include attribute information of a corresponding driver; the attribute information can include, for example, the age, the sex, the physical ability, the recognition ability, and/or driving ability of the corresponding driver.

The control parameters 410 are setting data required to dynamically and safely control the vehicle 2 in each of the autonomous driving modes. Plural settings for each control parameter 410 can be set depending on each driving-related condition. Based on commands sent from the adjustment apparatus 1, the autonomous driving controller 200 can be configured to determine settings of the respective control parameters 410.

For example, as described above, the control parameters 410 include at least one of

(1) A setting of the following distance between the vehicle 2 and a preceding vehicle

(2) A setting of acceleration or deceleration of the vehicle 2

(3) A setting of the steering rate of the vehicle 2, which can be obtained based on the measurement signal sent from the steering sensor of the sensors 22

For example, the setting of the following distance can be adjustable within the range from a first distance that enables the vehicle 2 travelling at a specific speed to be completely and safely stopped to a second distance having a safety margin compared to the first distance.

As an example, the setting of acceleration or deceleration of the vehicle 2 can be determined at a maximum value of acceleration or deceleration when the vehicle 2 is accelerated or decelerated in a safety state in the autonomous driving.

As another example, the setting of acceleration or deceleration of the vehicle 2 can be determined within the range from a fraction of 1 g-force to half of the maximum value of acceleration or the maximum value of deceleration.

As an example, the setting of the steering rate can be determined at a maximum value of the rate of steering change, i.e. a maximum value of an angular velocity, of the vehicle 2 when the vehicle 2 is safely tracking a curve.

As another example, the setting of the steering rate can be determined within the range from several degrees per second to tens of degrees per second. The setting of the steering rate can be determined as a functional equation of the curvature of a curve that the vehicle 2 is tracking.

As described above, the parameter adjuster 110 includes the reference settings 510 and the variable settings 520 for the respective control parameters 410.

The reference settings 510 can be respectively determined as default values.

As described above, the variable setting 520 for each of the control parameters 410 can be stored in the storage 11 to be correlated with a corresponding condition information file 500 that represents the corresponding one of the previously prepared respective intervention-responsive driving-related conditions C1, . . . , Cn (see FIG. 3). The variable setting 520 for each of the control parameters 410 can include information about the setting and type of at least one object to be recognized. The variable setting 520 for each of the control parameters 410 can be stored in the storage 11 in a database format, i.e. a tree format, such that various pieces of data are correlated with the variable setting 520.

As described above, each condition information file 500 represents the conditions, i.e. situations, of the corresponding autonomous driving of the vehicle 2. That is, each condition information file 500 can be comprised of information items (data items) generated by the autonomous driving controller 200 and used to be analyzed for determining the driving-related condition based on the data items. For example, the information items (data items) include the vehicle control condition information, the time condition information, the weather condition information, the road condition information, the traffic condition information, and the hazardous condition information set forth above. Each condition information file 500 can also be comprised of information about various objects recognized by the autonomous driving controller 200, and the images captured by the image sensor.

The information about the various objects recognized by the autonomous driving controller 200 can include, for example,

(1) Lanes, traffic signs, and/or buildings on a travelling road, such as an urban road or an express way

(2) Vectors of movable objects, such as other vehicles and pedestrians, included in the various objects

(3) Information about the location of at least one obstacle, the location of at least one sinkhole, the location of at least one accident happened on at least one road, and cargoes fallen on at least one road in the estimated travelling course of the vehicle 2 or its peripheral area

(4) Map Information

Each intervention-responsive condition information file 500 can also include what type of a corresponding driver's intervention is and/or driver's operation information based on a driver's operation of one of the driver operable devices 50.

The controller 10 of the adjustment apparatus 1 executes at least one of the control programs on the OS stored in the storage 11 to thereby serve as at least the condition obtainer 100 and the parameter adjuster 110.

The controller 20 of each vehicle 2 executes at least one of the control programs on the OS stored in the storage 21 to thereby serve as at least the autonomous driving controller 200 and the information sender 210.

At least one hardware resource can constitute each of the modules 100, 110, 200, and 210. At least one integrated circuit (IC), at least one digital signal processor, at least one programmed logic circuit or other similar hardware device can constitute at least part of the operations carried out by the controllers 10 and 20 described hereinbelow.

Next, the following describes an autonomous driving adjustment routine comprised of

(1) An autonomous driving control routine carried out by the controller 20 of each vehicle 2 every predetermined period

(2) A parameter setting routine carried out by the controller 10 of the adjustment apparatus 1 in cooperation with the controller 20

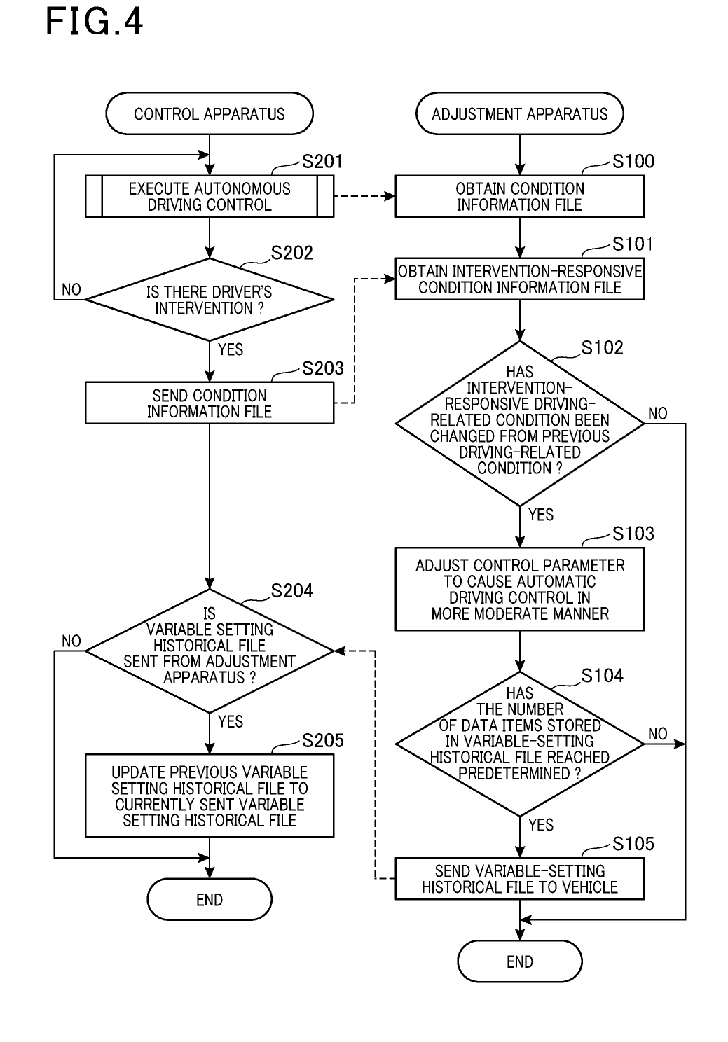

FIG. 4 schematically illustrates the autonomous driving adjustment routine. The following describes the autonomous driving adjustment routine cooperatively carried out by the controller 10 of the adjustment apparatus 1 and the controller 20 of one vehicle 2 for simplifying the descriptions of the autonomous driving adjustment routine.

When starting a current cycle of the autonomous driving control routine of the autonomous driving adjustment routine, the controller 20 of the vehicle 2 serves as the autonomous driving controller 200 to execute an autonomous driving control subroutine to thereby start the autonomous driving control of the vehicle 2 in accordance with

(1) The control parameters 410 stored in the storage 21

(2) The measurement signals sent from the sensors 22 in step S201

In step S201, while executing the autonomous driving control of the vehicle 2, the autonomous driving controller 200

(1) Obtains the vehicle control condition information and the environmental condition information successively sent from the sensors 22 and/or via the in-vehicle network

(2) Repeatedly, i.e. cyclically, generates a condition information file 500 based on the vehicle control condition information and the environmental condition information currently obtained thereby, thus storing the condition information file 500 in the storage 21

(3) Sends, to the adjustment apparatus 1, the condition information file 500 each time the autonomous driving controller 200 generates the condition information file 500 and stores it in the storage 21

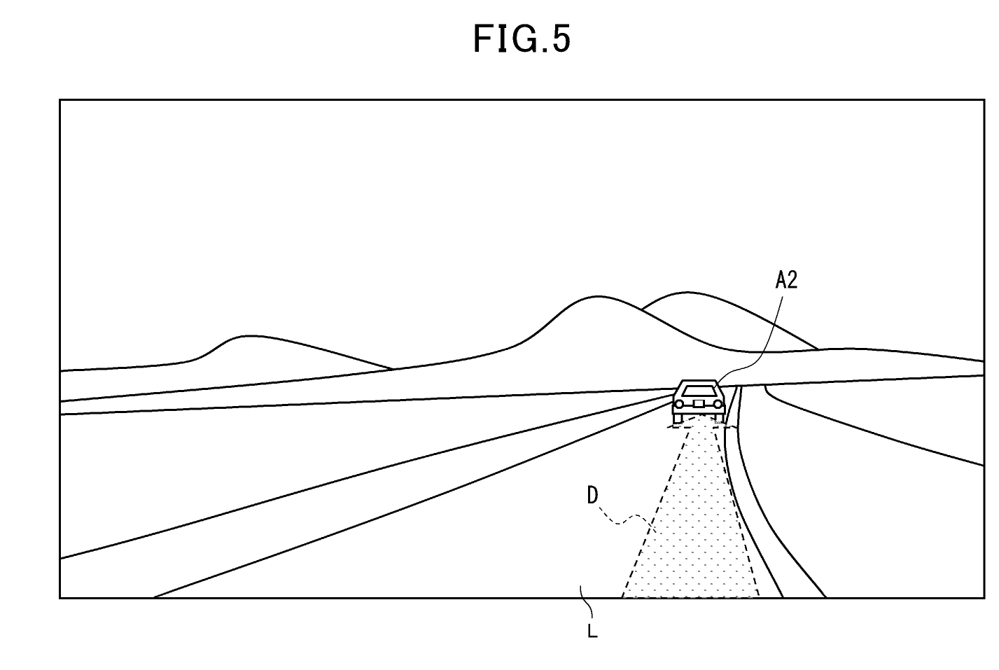

FIG. 5 schematically illustrates how the autonomous driving controller 200 is executing the autonomous driving control of the vehicle 2 to thereby

1. Control the steering of the vehicle 2 to keep the vehicle 2 in a current travelling lane L

2. Control the speed of the vehicle 2 to leave a following distance D between the vehicle 2 and a previous vehicle A2

How the autonomous driving controller 200 executes the autonomous driving control subroutine in step S201 in detail will be described later.

Next, the autonomous driving controller 200 determines whether there is a driver's intervention in the autonomous driving of the vehicle 2 while performing the operation in step S201 in step S202.

Upon determining that there are no driver's interventions in the autonomous driving of the vehicle 2 (NO in step S202), the autonomous driving controller 200 repeats the determination in step S202 while performing the operation in step S201.

Otherwise, upon determining that there is a driver's intervention in the autonomous driving of the vehicle 2 (YES in step S202), the autonomous driving adjustment routine proceeds to step S203.

In step S203, the autonomous driving controller 200 obtains, from the storage 21, the condition information file 500 that is generated at or closest to the occurrence of the driver's intervention in the autonomous driving of the vehicle 2. Then, in step S203, the information sender 210 sends, to the adjustment apparatus 1, the obtained condition information file 500 as an intervention-responsive condition information file 500.

Next, in step S204, the autonomous driving controller 200 determines whether a variable setting historical file F, i.e., the variable settings 520, is sent from the adjustment apparatus 1. Upon determining that the variable settings 520 are not sent from the adjustment apparatus 1 (NO in step S204), the autonomous driving controller 200 terminates the current cycle of the autonomous driving control routine, and executes the next cycle of the autonomous driving control routine from step S201.

On the other hand, the condition obtainer 100 starts the parameter setting routine to successively obtain the condition information file 500 and stores it in the condition DB 400 each time the condition information file 500 is sent thereto from the information sender 210 of the vehicle 2 in step S100.

In step S100, the condition obtainer 100 can store the condition information file 500 in the condition DB 400 while categorizing the condition information file 500 into vehicle control condition information, time condition information, weather condition information, road condition information, traffic condition information, and hazardous condition information.

In step S100, the condition obtainer 100 can store the condition information file 500 in the condition DB 400 such that the time of the corresponding file being stored is assigned to the condition information file 500.

At that time, when the intervention-responsive condition information file 500 is sent from the vehicle 2, the condition obtainer 100 obtains the intervention-responsive condition information file 500, and stores it in the condition DB 400 in step S101.

In step S101, the condition obtainer 100 can store the intervention-responsive condition information file 500 in the condition DB 400 while categorizing the intervention-responsive condition information file 500 into vehicle control condition information, time condition information, weather condition information, road condition information, traffic condition information, and hazardous condition information.

In step S101, the condition obtainer 100 can store the intervention-responsive condition information file 500 in the condition DB 400 such that the time of the corresponding file being stored is assigned to the intervention-responsive condition information file 500.

Then, the parameter adjuster 110 determines whether an intervention-responsive driving-related condition represented by the intervention-responsive condition information file 500 has been changed by at least the predetermined threshold amount from the previous driving-related condition represented by the condition information file 500 stored in the condition DB 400 immediately previous to the intervention-responsive condition information file 500 in step S102.

As the example illustrated in FIG. 5, the parameter adjuster 110 determines whether a value of the following distance D as the traffic condition represented by the intervention-responsive condition information file 500 has been changed by at least the predetermined threshold amount from a value of the following distance D as the traffic condition represented by the condition information file 500 stored in the condition DB immediately previous to the intervention-responsive condition information file 500 in step S102.

Upon it being determined that the intervention-responsive driving-related condition represented by the intervention-responsive condition information file 500 has been changed by at least the predetermined threshold amount from the previous driving-related condition represented by the condition information file 500 stored in the condition DB 400 immediately previous to the intervention-responsive condition information file 500 (YES in step S102), the autonomous driving adjustment routine proceeds to step S103.

Otherwise, upon it being determined that the intervention-responsive driving-related condition represented by the intervention-responsive condition information file 500 has not been changed by at least the predetermined threshold amount from the previous driving-related condition represented by the condition information file 500 stored in the condition DB 400 immediately previous to the intervention-responsive condition information file 500 (NO in step S102), the controller 10 terminates the current cycle of the parameter setting routine, and executes the next cycle of the parameter setting routine.

In the example illustrated in FIG. 5, the parameter adjuster 110 calculates a change of the following distance D based on a change of the moving vector of the preceding vehicle A2 and a change of the speed of the vehicle 2 based on comparison the traffic condition represented by the intervention-responsive condition information file 500 and the traffic condition represented by the condition information file 500 stored in the condition DB 400 immediately previous to the intervention-responsive condition information file 500 in step S102.

In the example illustrated in FIG. 5, the parameter adjuster 110 determines whether the calculated change of the following distance D has exceeded a predetermined threshold range in step S102.

Upon determining that the calculated change of the following distance D has exceeded the predetermined threshold range, the parameter adjuster 110 executes affirmative determination in step S102.

Otherwise, upon determining that the calculated change of the following distance D has not exceeded the predetermined threshold range, the parameter adjuster 110 performs negative determination in step S102.

Note that, in step S102, the parameter adjuster 110 can be configured to perform the determination for each of the remaining conditions, i.e. the vehicle control condition, the time condition, the weather condition, the road condition, and the hazardous condition information.

In step S103, the parameter adjuster 110 adjusts at least one of the control parameters 410 to thereby cause the autonomous driving control of the vehicle 2 to be in a more moderate manner.

For example, in step S103, the parameter adjuster 110 calculates a value of at least one of the variable settings 520 of the respective control parameters 410, and changes the current value of at least one of the variable settings 520 of the respective control parameters 410 in a more moderate manner. In the example illustrated in FIG. 5, the parameter adjuster 110 changes a value of the following distance D to be longer.

Then, in step S103, the parameter adjuster 110 stores, in the storage 11, at least one of the variable settings 520 having the changed value to be correlated with the corresponding the intervention-responsive driving-related condition as a data item of the variable-setting historical file F (see FIG. 3).

Note that, in step S103, upon determining, based on the intervention-responsive condition information file 500, that the driver's intervention is based on a driver's operation of one of the second group of devices in the driver operable devices 50 that are not directly associated with the driving of the vehicle 2, the parameter adjuster 110 can adjust at least one of the control parameters 410 to thereby cause the autonomous driving control of the vehicle 2 to be in a sharper manner. In the example illustrated in FIG. 5, the parameter adjuster 110 can change a value of the following distance D to be shorter.

In step S104, the parameter adjuster 110 determines whether the number of the data items of the variable settings 520 set for the respective intervention-responsive driving-related conditions in the variable-setting historical file F in step S103 has reached a predetermined threshold number.

Upon determining that the number of the data items of the variable settings 520 set for the respective intervention-responsive driving-related conditions in the variable-setting historical file F in step S103 has not reached the predetermined threshold number (NO in step S104), the parameter adjuster 110 terminates the current cycle of the parameter setting routine, and executes the next cycle of the parameter setting routine from step S100.

Otherwise, upon determining that the number of the data items of the variable settings 520 set for the respective intervention-responsive driving-related conditions in the variable-setting historical file F in step S103 has reached the predetermined threshold number (YES in step S104), the parameter adjuster 110 sends the variable-setting historical file F to the vehicle 2 in step S105. Thereafter, the controller 10 terminates the parameter setting routine.

When the variable-setting historical file F is sent from the adjustment apparatus 1 to the vehicle 2, the autonomous driving controller 200 executes affirmative determination in step S204 in a corresponding cycle of the autonomous driving control routine.

Then, the autonomous driving controller 200 stores the received variable-setting historical file F including the adjusted variable settings 520 for the respective control parameters 410 in the storage 21 or updates the last stored variable-setting historical file F to the received variable-setting historical file F in step S205. This enables, in at least one of the following cycles of the autonomous driving control routine, the updated variable settings 520 for the respective control parameters 410 to be executed as described later. Thereafter, the controller 20 terminates the autonomous driving control routine.

Note that the parameter adjuster 110 can be configured to use, for example, a file transfer protocol (FTP) to thereby directly change the variable settings 520 stored in the storage 21 of the control apparatus 2a.

The parameter adjuster 110 can be configured not to perform the operations in steps S102 to S105 in real-time, i.e. during execution of the autonomous driving, but to statistically analyze the condition information files 500 including the intervention-responsive condition information files 500 stored in the condition DB 400 to thereby perform the operations in steps S102 to S105 after execution of the autonomous driving, thus updating the last stored variable settings 520 in the storage 21 to the newly determined variable settings 520 for the respective control parameters 410.

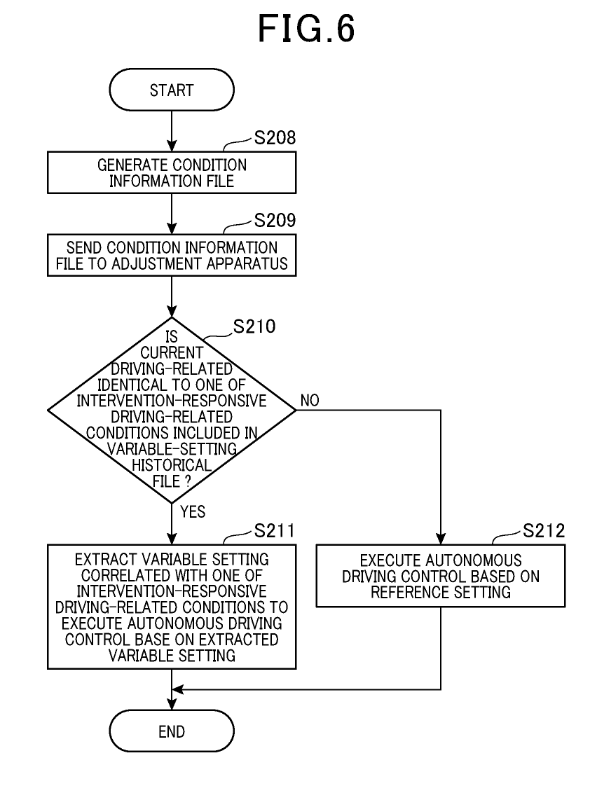

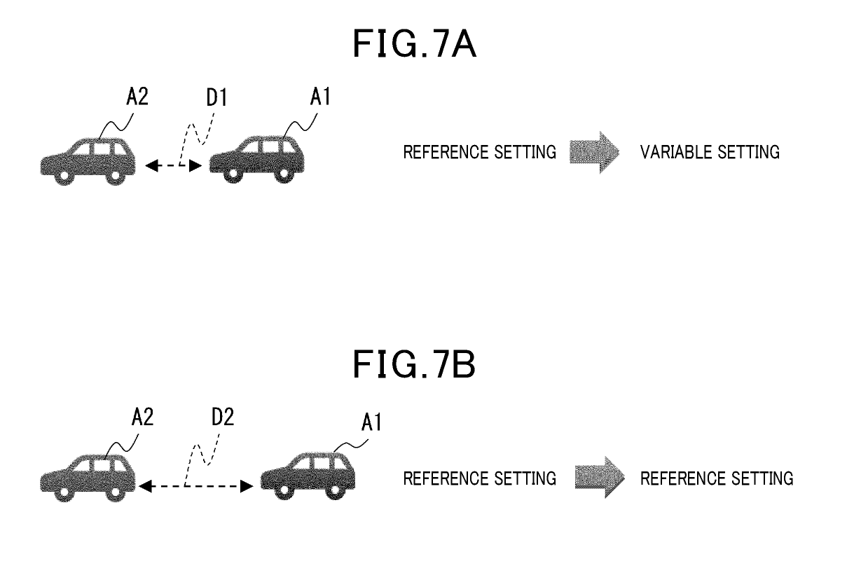

Next, the following describes the autonomous driving control subroutine in step S201 in detail with reference to FIGS. 6, 7A, and 7B.

That is, the autonomous driving controller 200 obtains the vehicle control condition information and the environmental condition information successively sent from the sensors 22 and/or via the in-vehicle network to thereby repeatedly, i.e. cyclically, generate a condition information file 500 based on the vehicle control condition information and the environmental condition information currently obtained thereby, thus storing the condition information file 500 in the storage 21 in step S208.

Then, the autonomous driving controller 200 sends, to the adjustment apparatus 1, the condition information file 500 each time the autonomous driving controller 200 generates the condition information file 500 and stores it in the storage 21 in step S209.

In particular, the autonomous driving controller 200 refers to the variable-setting historical file F stored in the storage 21, and determines whether a current driving-related condition based on the currently generated condition information file 500 is substantially identical to the intervention-responsive driving-related conditions included in the variable-setting historical file F in step S210.

Upon it being determined that the current driving-related condition based on the currently generated condition information file 500 is substantially identical to one of the intervention-responsive driving-related conditions included in the variable-setting historical file F (YES in step S210), the autonomous driving control subroutine proceeds to step S211. Otherwise, it being determined that the current driving-related condition based on the currently generated condition information file 500 is not substantially identical to any of the intervention-responsive driving-related conditions included in the variable-setting historical file F (NO in step S210), the autonomous driving control subroutine proceeds to step S212.

In step S212, the autonomous driving controller 200 can determine whether the current driving-related condition based on the currently generated condition information file 500 is changed by at least a predetermined amount from the previous driving-related condition based on the condition information file 500 generated immediately previous to the currently generated condition information file 500.

For example, FIG. 7A illustrates that a current driving-related condition in which the following distance between the vehicle 2 and a preceding vehicle A2 is set to a value D1. If the current value D1 of the following distance is included in the variable-setting historical file F or is changed from the last value of the following distance between the vehicle 2 and the preceding vehicle A2 by at least a predetermined amount, the determination in step S210 becomes affirmative.

In contrast, FIG. 7B illustrates that a current driving-related condition in which the following distance between the vehicle 2 and a preceding vehicle A2 is set to a value D2. If the current value D2 of the following distance is not included in the variable-setting historical file F or is not changed by the at least predetermined amount from the last value of the following distance between the vehicle 2 and the preceding vehicle A2, the determination in step S210 becomes negative.

In step S211, the autonomous driving controller 200 extracts the variable settings 520 for the respective control parameters 410 included in the variable-setting historical file F, which are correlated with or are close to the current driving-related condition. Then, in step S211, the autonomous driving controller 200 executes the autonomous driving control of the vehicle 2 in accordance with

(1) The extracted variable settings 520 of the respective control parameters 410 stored in the storage 21 in place of the reference settings 510 of the respective control parameters 410

(2) The measurement signals sent from the sensors 22

In step S212, the autonomous driving controller 200 executes the autonomous driving control of the vehicle 2 in accordance with

(1) The reference settings 510 of the respective control parameters 410 stored in the storage 21

(2) The measurement signals sent from the sensors 22

After completion of the operation in step S211 or S212, i.e. after completion of the autonomous driving control subroutine, the autonomous driving controller 200 returns to step S202 of the main autonomous driving control routine, and sequentially executes the following operations.

As described in detail above, the autonomous driving adjustment system X achieves the following benefits.

Even if a conventional autonomous driving technology objectively ensures safety autonomous driving to drivers, not all of various types of drivers necessarily have a sense of safety due to their individual differences. For this reason, many drivers seem to have an impersonal feeling about conventional autonomous driving, resulting in many drivers having a difficulty of having a secure feeling. Actually, autonomous driving control of a vehicle for safety can be adapted to the driver's driving tastes or senses. Adjustment of autonomous driving control of a vehicle based on driver's driving tastes enables whether a driver has a secure feeling or the level of the driver having a secure feeling to be changed.

How much autonomous driving control of a vehicle is adjusted based on driver's tastes or senses and/or the level of drivers having a secure feeling depend on the driver's individual differences. For this reason, it is desired to provide a method of adjusting autonomous driving control of a vehicle based on driver's tastes or senses, which is capable of offering a secure feeling to an average driver with high probability.

Unfortunately, the technology disclosed in the published patent document may make it difficult to ensure the robustness of autonomous driving control, because the technology disclosed in the published patent document performs autonomous driving control based on an estimated driver's feeling, which is an unstable factor. This may result in the accuracy of the autonomous driving control deteriorating and make it difficult to execute autonomous driving control suitable for driver's preferences.

From this viewpoint, the autonomous driving adjustment system X includes at least one vehicle 2 capable of being autonomous driven and the adjustment apparatus 1 for adjusting how each of the vehicles 2 is autonomously controlled.

Specifically, the at least one vehicle 2 includes the autonomous driving controller 200 and the information sender 210.

The autonomous driving controller 200 is configured to control the actuators 40 to perform autonomous driving of the vehicle 2 in accordance with

(1) Settings of the control parameters 410 stored in the storage 21

(2) The measurement signals sent from the sensors 22

The autonomous driving controller 200 is also configured to

1. Repeatedly generate a condition information file 500 based on the vehicle control condition information and the environmental condition information currently obtained thereby, thus storing the condition information file 500 in the storage 21

2. Obtain, as an intervention-responsive condition information file 500, a condition information file 500 generated at or closest to the occurrence of a driver's intervention to the automatic driving control

The information sender 210 sends, to the adjustment apparatus 1, the condition information files 500 including the intervention-responsive condition information file 500 each time one of the condition information files 500 is generated by the autonomous driving controller 200.

The adjustment apparatus 1 includes the condition obtainer 100 and the parameter adjuster 110.

The condition obtainer 100 obtain the condition information file 500 and stores it in the condition DB 400 each time the condition information file 500 is sent thereto from the information sender 210 of the vehicle 2.

In particular, when the intervention-responsive condition information file 500 is sent from the vehicle 2, the condition obtainer 100 obtains the intervention-responsive condition information file 500, and stores it in the condition DB 400.

The parameter adjuster 110 analyses an intervention-responsive driving-related condition represented by the intervention-responsive condition information file 500 to thereby determine whether the intervention-responsive driving-related condition represented by the intervention-responsive condition information file 500 has been changed by at least the predetermined threshold amount from the last driving-related condition represented by the condition information file 500 lastly stored in the condition DB 400 immediately previous to the intervention-responsive condition information file 500.

The parameter adjuster 110 adjusts at least one of the control parameters 410 when the intervention-responsive driving-related condition represented by the intervention-responsive condition information file 500 has been changed by at least the predetermined threshold amount from the last driving-related condition represented by the condition information file 500 lastly stored in the condition DB 400 immediately previous to the intervention-responsive condition information file 500.

That is, the parameter adjuster 110 analyses the intervention-responsive driving-related condition represented by the intervention-responsive condition information file 500 generated at or close to the timing of a driver's intentional intervention in the autonomous driving control, i.e. a driver's positive feedback to the automatic driving control, thus adjusting at least one of the control parameters 410. This therefore enables at least one of the control parameters 410 to be adjusted to satisfy the driver's preferences during the autonomous driving control, resulting in reduction of driver's uncomfortable feeling about the autonomous driving of the vehicle 2.

In other words, the autonomous driving adjustment system X makes it possible to adjust the autonomous driving control based on the driver's driving tastes or senses to satisfy the driver's preferences.

In addition, it may be difficult to perform tests for checking an adjustable range of each control parameter 410 for the automatic driving control; this adjustable range of each control parameter 410 shows whether a driver has an anxious feeling while the actual automatic driving is being carried out. In other words, it may be difficult to know an accurate range of adjustment of each control parameter 410 for the automatic driving control even while the safety of the automatic driving is ensured; this accurate range of adjustment of each control parameter 410 shows that, if an adjusted setting of at least one of the control parameters 410 is set outside the accurate range, a corresponding driver seems to have an anxious feeling about the automatic driving control.

For determining the relationships between driver's secure feelings and adjustment of the control parameters 410 for the automatic driving control based on driver's driving tastes, it may be necessary to collect a large amount of data about the driver's security feelings with respect to adjustment of the control parameters 410, and analyze the collected data. In addition, because surveys are carried out to collect the data, it may be difficult to accurately collect the driver's security feelings.

In contrast, the autonomous driving adjustment system X is configured to collect driving-related conditions during execution of the autonomous driving control of the vehicle 2, each of which is responsive to a corresponding one of driver's interventions in the autonomous driving control of the vehicle 2; the conventional technology disclosed in the published patent document or surveys may result in a difficult of collecting these driving-related conditions. In addition, the autonomous driving adjustment system X is capable of analyzing the relationship between the intervention-responsive conditions and the respective driver's interventions, making it possible to statistically model the driver's preferences to be suitable for the driver's driving tastes. That is, analyzing the intervention-responsive conditions, each of which has occurred due to a driver's anxious feeling, although the autonomous driving control is safely carried out makes it possible to accurately evaluate what type of driving-related conditions and autonomous driving control tasks cause a driver to feel anxiety. This therefore enables autonomous driving control of the vehicle 2 to be carried out while providing a more secure feeling to drivers of the vehicle 2.

To sum up, the autonomous driving adjustment system X makes it possible to adjust the settings of the control parameters 410 for autonomous driving control based on the driver's driving tastes while learning the driver's preferences, thus carrying out autonomous driving of the vehicle 2, which sufficiently meet the driver's preferences.

The adjustment apparatus 1 according to the exemplary embodiment of the present disclosure is configured to adjust, as the control parameters 410 for the autonomous driving control, the following distance between the vehicle 2 and a preceding vehicle, the acceleration or deceleration of the vehicle 2, and/or the steering rate of the vehicle 2.

This configuration enables the following distance between the vehicle 2 and the preceding vehicle, the acceleration or deceleration of the vehicle 2, and/or the steering rate of the vehicle 2 to be controlled to be suitable for the driver's preferences, making it possible to carryout autonomous driving of the vehicle 2 without the driver having an anxious feeling while ensuring the safety of the vehicle 2.

The parameter adjuster 110 of the adjustment apparatus 1 includes

(1) The reference settings 510 for the respective control parameters 420, which are kept unchanged independently of driver's interventions

(2) The variable settings 520 for the respective control parameters 420, which are adjusted depending on driver's interventions.

Specifically, the parameter adjuster 110 is configured to adjust at least one of the variable settings 520 each time a driver's intervention occurs, thus generating a variable-setting historical file F including the adjusted values 520a1, . . . , 520an of each variable setting 520 for the corresponding one of the control parameters 410 to be correlated with the respective intervention-responsive driving-related conditions C1, . . . , Cn in, for example, a table format (see FIG. 3).

In addition, the parameter adjuster 110 is configured to send the variable-setting historical file F to the vehicle 2.

This enables, if the current driving-related condition based on the currently generated condition information file 500 is included in the variable-setting historical file F, the autonomous driving controller 200 to

(1) Extract the variable settings 520 for the respective control parameters 410 included in the variable-setting historical file F, which are correlated with or are close to the current driving-related condition

(2) Execute the autonomous driving control of the vehicle 2 in accordance with the extracted variable settings 520 of the respective control parameters 410 stored in the storage 21 in place of the reference settings 510 of the respective control parameters 410

This configuration of the parameter adjuster 110 enables values of the control parameters 410 for the autonomous driving control to be easily returned from the variable settings 520 to the reference settings 510 if

(1) A driver has increased his or her driving skills so that the driver does not like the autonomous driving control based on the variable settings 520 for the respective control parameters 410 or

(2) The variable settings 520 for the respective control parameters 410 are erroneously determined due to, for example over-training of the variable settings 520

That is, this enables the values of the control parameters 410 for the autonomous driving control to be easily changed from the variable settings 520 to the reference settings 510 if the variable settings 520 do not reflect an actual driver's preferences. This therefore makes it possible to perform autonomous driving of the vehicle 2 to be more suitable for the driver's preferences.

During the autonomous driving of the vehicle 2, maximum extent control of the following distance, acceleration, or deceleration of the vehicle 2 may cause the driver of the vehicle 2 to have an anxious feeling or an uncomfortable feeling. This may result in how to execute the autonomous driving control suitable for the driver's driving tastes being at the stage of trial and error.

From this viewpoint, the parameter adjuster 110 of the adjustment apparatus 1 is configured to adjust a value of at least one of the control parameters 410 to thereby execute control of the autonomous driving of the vehicle 2 in a more moderate manner in response to a driver's intervention.

This configuration enables maximum extent control for autonomous driving to be carried out while providing the driver from having a feeling of discomfort as much as possible, making it possible to perform autonomous driving of the vehicle 2 to be further suitable for the driver's preferences.

The adjustment apparatus 1 can be installed in each of the vehicles 2 so that the adjustment apparatus 1 and the control apparatus 2a constitute the autonomous driving adjustment system X for the corresponding vehicle 2.

While the illustrative embodiment of the present disclosure has been described herein, the present disclosure is not limited to the embodiment and its modifications described herein, but includes any and all embodiments having modifications, omissions, combinations (e.g., of aspects across various embodiments), adaptations and/or alterations as would be appreciated by those in the art based on the present disclosure within the scope of the present disclosure.

For example, each of the technical features described in the embodiment and its modifications can be replaced with a known structure having the same function as the corresponding technical feature. Each of the technical features described in the embodiment and its modifications can also be combined with at least one of the other technical features. At least one of the technical features described in the embodiment and its modifications can further be eliminated unless the at least one of the technical features is described as an essential element in the present specification.

What is claimed is:

1. An autonomous driving adjustment apparatus for adjusting at least one control parameter used for execution of autonomous driving control of a vehicle, the autonomous driving adjustment apparatus comprising:
a condition obtainer configured to repeatedly obtain a driving-related condition during execution of autonomous driving control of a vehicle, the driving-related condition including at least one of control information about the autonomous driving control of the vehicle, and environmental condition information around the vehicle during execution of the autonomous driving control of the vehicle,
the condition obtainer being configured to obtain the driving-related condition in response to a driver's intervention in the autonomous driving control of the vehicle as an intervention-responsive driving-related condition; and
a parameter adjuster configured to:
determine whether the intervention-responsive driving-related condition has been changed from a previous driving-related condition in the driving-related conditions, the previous driving-related condition being obtained immediately previous to the intervention-responsive condition; and
adjust the at least one control parameter for the intervention-responsive driving-related condition upon determining that the intervention-responsive driving-related condition has been changed from the previous driving-related condition.

2. The autonomous driving adjustment apparatus according to claim 1, wherein:
the at least one control parameter includes at least one of
a following distance between the vehicle and a preceding vehicle;
acceleration of the vehicle;
deceleration of the vehicle; and
a steering rate of the vehicle.

3. The autonomous driving adjustment apparatus according to claim 1, wherein:
the parameter adjuster is configured to adjust the at least one control parameter to thereby cause the autonomous driving control of the vehicle to be more moderate.

4. The autonomous driving adjustment apparatus according to claim 1, wherein:
the parameter adjuster includes:
a reference setting of the at least one control parameter; and
a variable setting of the at least one control parameter,
the parameter adjuster being configured to adjust the variable setting of the at least one control parameter for the intervention-responsive driving-related condition while maintaining the reference setting of the at least one control parameter unchanged upon determining that the intervention-responsive driving-related condition has been changed from the previous driving-related condition.

5. The autonomous driving adjustment apparatus according to claim 4, wherein:
the condition obtainer is configured to obtain the driving-related condition each time the driver's intervention in the autonomous driving control of the vehicle occurs as the intervention-responsive driving-related condition; and
the parameter adjuster is configured to:
determine whether each of the intervention-responsive driving-related conditions has been changed from the previous driving-related condition, the previous driving-related condition being obtained immediately previous to the corresponding one of the intervention-responsive driving-related conditions;
change the variable setting of the at least one control parameter for each of the intervention-responsive driving-related conditions to be an adjusted variable setting upon determining that each of the intervention-responsive driving-related conditions has been changed from the previous driving-related condition; and
store, in a storage, the adjusted variable settings for the respective intervention-responsive driving-related conditions to be correlated with the respective intervention-responsive driving-related conditions as a variable setting historical file.

6. An autonomous driving adjustment system comprising:
a control apparatus to be installed in a vehicle; and
an autonomous driving adjustment apparatus,
the control apparatus comprising:
an autonomous driving controller configured to execute autonomous driving control of the vehicle in accordance with at least one control parameter, and
an information sender configured to repeatedly send, to the autonomous driving adjustment apparatus, a driving-related condition while the autonomous driving controller is executing the autonomous driving control of the vehicle, the driving-related condition including at least one of control information about the autonomous driving control of the vehicle, and environmental condition information around the vehicle,
the information sender being configured to send, to the autonomous driving adjustment apparatus, the driving-related condition in response to a driver's intervention in the autonomous driving control of the vehicle as an intervention-responsive driving-related condition; and
the autonomous driving adjustment apparatus comprising:
a condition obtainer configured to obtain the driving-related conditions sent from the information sender, the driving-related conditions including the intervention-responsive driving-related condition; and
a parameter adjuster configured to:
determine whether the intervention-responsive driving-related condition has been changed from a previous driving-related condition in the driving-related conditions, the previous driving-related condition being obtained immediately previous to the intervention-responsive condition; and
adjust the at least one control parameter for the intervention-responsive driving-related condition upon determining that the intervention-responsive driving-related condition has been changed from the previous driving-related condition.

7. The autonomous driving adjustment system according to claim 6, wherein:
the parameter adjuster includes:
a reference setting of the at least one control parameter; and
a variable setting of the at least one control parameter,
the parameter adjuster being configured to adjust the variable setting of the at least one control parameter for the intervention-responsive driving-related condition while maintaining the reference setting of the at least one control parameter unchanged upon determining that the intervention-responsive driving-related condition has been changed from the previous driving-related condition.

8. The autonomous driving adjustment system according to claim 7, wherein:
the condition obtainer is configured to obtain the driving-related condition each time the driver's intervention in the autonomous driving control of the vehicle occurs as the intervention-responsive driving-related condition; and
the parameter adjuster is configured to:
determine whether each of the intervention-responsive driving-related conditions has been changed from the previous driving-related condition, the previous driving-related condition being obtained immediately previous to the corresponding one of the intervention-responsive driving-related conditions;
change the variable setting of the at least one control parameter for each of the intervention-responsive driving-related conditions to be an adjusted variable setting upon determining that each of the intervention-responsive driving-related conditions has been changed from the previous driving-related condition; and
store, in a storage, the adjusted variable settings for the respective intervention-responsive driving-related conditions to be correlated with the respective intervention-responsive driving-related conditions as a variable setting historical file.

9. The autonomous driving adjustment system according to claim 8, wherein:
the parameter adjuster is configured to:
send, to the control apparatus, the variable setting historical file; and
the autonomous driving controller is configured to:
receive the variable setting historical file;
determine whether a current driving-related condition currently obtained by the condition obtainer is substantially identical to one of the intervention-responsive driving-related conditions included in the variable setting historical file;
upon determining that the current driving-related condition is substantially identical to one of the intervention-responsive driving-related conditions included in the variable setting historical file, extract one of the variable settings, the extracted one of the variable settings being correlated with the one of the intervention-responsive driving-related conditions; and
change the reference setting of the at least one control parameter to the extracted one of the variable settings.

10. An autonomous driving adjustment method for adjusting at least one control parameter used for execution of autonomous driving control of a vehicle, the autonomous driving adjustment method comprising:
repeatedly obtaining a driving-related condition during execution of autonomous driving control of a vehicle, the driving-related condition including at least one of control information about the autonomous driving control of the vehicle, and environmental condition information around the vehicle during execution of the autonomous driving control of the vehicle,
the obtaining step obtaining the driving-related condition in response to a driver's intervention in the autonomous driving control of the vehicle as an intervention-responsive driving-related condition;
determining whether the intervention-responsive driving-related condition has been changed from a previous driving-related condition in the driving-related conditions, the previous driving-related condition being obtained immediately previous to the intervention-responsive condition; and
adjusting the at least one control parameter for the intervention-responsive driving-related condition upon determining that the intervention-responsive driving-related condition has been changed from the previous driving-related condition.
